(19) United States
(12) Patent Application Publication
(10) Pub. No.: US 2025/0041849 A1
(43) Pub. Date: Feb. 6, 2025

(54) MICROFLUIDIC CHIP, MICROFLUIDIC DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Fan Yang, Beijing (CN); Lin Deng, Beijing (CN); Ding Ding, Beijing (CN); Zhukai Liu, Beijing (CN)

(21) Appl. No.: 18/579,436

(22) PCT Filed: Aug. 18, 2022
(86) PCT No.: PCT/CN2022/113193

§ 371 Date: Jan. 15, 2024

(51) Int. Cl. B01L 3/00

(52) U.S. Cl. CPC B01L 3/502715; B01L 2200/027; B01L 2300/0809; B01L 2300/0867

(57) ABSTRACT

The present disclosure provides a microfluidic chip and a microfluidic device including the microfluidic chip. The microfluidic chip includes at least two units stacked in a first direction perpendicular to the microfluidic chip, each unit of the at least two units includes a generation part configured to generate a target fluid.

### RELATED APPLICATIONS

The present application is a 35 U.S.C. 371 national stage application of PCT International Application No. PCT/CN2022/113193 filed on Aug. 18, 2022, the entire disclosure of which is incorporated herein by reference.

### TECHNICAL FIELD

The present disclosure relates to the field of microfluidics, in particular to a microfluidic chip and a microfluidic device comprising the microfluidic chip.

### BACKGROUND

Microfluidics is a technology that precisely controls and manipulates micro-scale fluids. Through this technology, the basic operation units involved in the detection and analysis process, such as sample preparation, reaction, separation, and detection, can be integrated on a centimeter-scale chip. Microfluidics is generally used in the analysis process of trace drugs in the fields of biology, chemistry, and medicine. The microfluidic device has advantages such as less sample consumption, fast detection speed, easy operation, multi-functional integration, small size, and portability, and has great application potential in the fields of biology, chemistry, and medicine.

### SUMMARY

According to an aspect of the present disclosure, a microfluidic chip is provided. The microfluidic chip comprises at least two units stacked in a first direction perpendicular to the microfluidic chip, each of the at least two units comprises a generation part that is configured to generate a target fluid.

In some embodiments, each unit further comprises a delivery channel downstream of the generation part, an inlet of the delivery channel of each unit is in communication with the generation part, and the delivery channels of all units comprise a first delivery channel closest to a bottom surface of the microfluidic chip in the first direction and remaining delivery channels, each of the remaining delivery channels is in direct or indirect communication with the first delivery channel, and the first delivery channel comprises a fluid outlet.

In some embodiments, the generation part of each unit comprises a first channel and a second channel which merge at a confluence region.

In some embodiments, the microfluidic chip further comprises a first inlet and a second inlet. The first channels of all units communicate with each other via a first connection channel, and the first channels of all units share the first inlet. The second channels of all units communicate with each other via a second connection channel, and the second channels of all units share the second inlet.

In some embodiments, the microfluidic chip further comprises at least two first inlets and at least two second inlets respectively corresponding to the at least two units one by one. The first channel of each of the at least two units corresponds to a respective one of the at least two first inlets, and the second channel of each of the at least two units corresponds to a respective one of the at least two second inlets.

In some embodiments, the microfluidic chip comprises 2N units stacked in the first direction, where N is a positive integer.

In some embodiments, orthographic projections of the confluence regions of all units on the microfluidic chip do not overlap with each other.

In some embodiments, a number of the confluence regions is 2N, a connection line of orthographic projections of N confluence regions among the 2N confluence regions on the microfluidic chip basically forms a first straight line, a connection line of orthographic projections of remaining N confluence regions among the 2N confluence regions on the microfluidic chip basically forms a second straight line, and the first straight line and the second straight line are axisymmetric with respect to a symmetrical axis.

In some embodiments, an outlet of each of the remaining delivery channels intersects with the first delivery channel.

In some embodiments, the first delivery channel is arranged parallel to a reference plane where the microfluidic chip is located, and each of the remaining delivery channels has a slope relative to the first delivery channel.

In some embodiments, a slope angle between each of the remaining delivery channels and the first delivery channel is 10°˜30°.

In some embodiments, the delivery channels of all units are arranged in a spiral manner in the first direction, and any two adjacent delivery channels in the first direction among the delivery channels of all units are directly connected to each other.

In some embodiments, the delivery channel of each unit has an S-shaped shape.

In some embodiments, the microfluidic chip further comprises a collector downstream of the delivery channel.

In some embodiments, the collector comprises a first sub-collector, and the first sub-collector communicates with the fluid outlet of the first delivery channel.

In some embodiments, the collector comprises a first sub-collector and a second sub-collector.

In some embodiments, the microfluidic chip further comprises a sorting channel between the fluid outlet of the first delivery channel and the collector, the sorting channel comprises a first sub-sorting channel and a second sub-sorting channel, the first sub-sorting channel communicates with the first sub-collector, and the second sub-sorting channel communicates with the second sub-collector.

In some embodiments, each unit further comprises a buffer channel between the confluence region and the delivery channel.

In some embodiments, the generation part of each unit further comprises a third channel, the first channel, the second channel and the third channel merge at the confluence region.

In some embodiments, the microfluidic chip further comprises a third inlet. The third channels of all units communicate with each other via a third connection channel, and the third channels of all units share the third inlet.

In some embodiments, the microfluidic chip further comprises at least two third inlets corresponding to the at least two units one by one, the third channel of each of the at least two units corresponds to a respective one of the at least two third inlets.

In some embodiments, one of the first channel and the second channel comprises at least one concave structure at the confluence region, a size of the first channel or the second channel comprising the concave structure at the confluence region is smaller than a size of the channel at a non-confluence region.

In some embodiments, the first channel has a first width along a second direction at the non-confluence region, the second channel has a second width along a third direction at the non-confluence region, and the second direction is substantially perpendicular to the third direction and both the second direction and the third direction are in a reference plane parallel to the microfluidic chip.

In some embodiments, the first channel comprises two symmetrical concave structures at the confluence region, a ratio of a width of each of the two symmetrical concave structures along the second direction to the first width is ⅙ to ⅓, and a height of each of the two symmetrical concave structures along the third direction is equal to the second width.

In some embodiments, the second channel comprises the concave structure at the confluence region, and a ratio of a height of the concave structure along the third direction to the second width is ¼ to ½.

In some embodiments, a ratio of a width of the concave structure along the second direction to the first width is ⅓ to ⅔, and a centerline of the concave structure along the third direction coincides with a centerline of the first channel along the third direction.

In some embodiments, a width of the concave structure along the second direction is equal to the first width, and a centerline of the concave structure along the third direction coincides with a centerline of the first channel along the third direction.

In some embodiments, a width of the concave structure along the second direction is equal to the first width, a centerline of the concave structure along the third direction is offset in the second direction relative to a centerline of the first channel along the third direction, and a ratio of an offset distance to the first width is ⅓ to 1.

In some embodiments, the generation part of each unit further comprises a third channel, the second channel is between the first channel and the third channel, and the first channel, the second channel and the third channel merge at the confluence region, and the first channel comprises a first concave structure at the confluence region, the third channel comprises a second concave structure at the confluence region, and the first concave structure and the second concave structure are symmetrical about the second channel.

In some embodiments, a non-confluence region of the third channel has a third width along the second direction, the third width is equal to the first width, and a ratio of a width of each of the first concave structure and the second concave structure along the second direction to the first width is ¼ to ½, and a height of each of the first concave structure and the second concave structure along the third direction is equal to the second width.

According to another aspect of the present disclosure, a microfluidic device is provided, which comprises the microfluidic chip described in any one of the previous embodiments.

### BRIEF DESCRIPTION OF THE DRAWINGS

In order to more clearly describe the technical solutions in the embodiments of the present disclosure, the drawings needed in the embodiments will be briefly described below. Obviously, the drawings described below are only some embodiments of the present disclosure. For those of ordinary skill in the art, other drawings may also be obtained based on these drawings without undue experimentation.

FIG. 1 illustrates a schematic structural diagram of a microfluidic chip according to an embodiment of the present disclosure;

FIG. 2 illustrates an enlarged view of the region I of FIG. 1(d);

FIG. 3 illustrates an enlarged view of the region II of FIG. 1(d);

FIG. 4 illustrates a schematic structural diagram of a microfluidic chip according to an embodiment of the present disclosure;

FIG. 5 illustrates an enlarged view of the region III of FIG. 4(d);

FIG. 6 illustrates a schematic structural diagram of a microfluidic chip according to an embodiment of the present disclosure;

FIG. 7 illustrates an enlarged view of the region IV of FIG. 6(c);

FIG. 8 illustrates a schematic diagram of channels of the generation part of each unit;

FIG. 9 illustrates a schematic structural diagram of a microfluidic chip according to an embodiment of the present disclosure;

FIG. 10 illustrates a cross-sectional view of the delivery channels in the multiple layers taken along the line AA′ of FIG. 9(c);

FIG. 11 illustrates a schematic structural diagram of a microfluidic chip according to an embodiment of the present disclosure;

FIG. 12 illustrates an enlarged view of the region V of FIG. 11(c);

FIG. 13 illustrates a schematic structural diagram of a microfluidic chip according to an embodiment of the present disclosure;

FIG. 14 illustrates simulation comparison diagrams of the generated droplet, (a) the confluence region of the microfluidic chip has no concave structure; (b) the confluence region of the microfluidic chip has the concave structure illustrated in FIG. 13;

FIG. 15 illustrates a schematic structural diagram of a microfluidic chip according to an embodiment of the present disclosure;

FIG. 16 illustrates simulation comparison diagrams of the generated droplet, (a) the confluence region of the microfluidic chip has no concave structure; (b) the confluence region of the microfluidic chip has the concave structure illustrated in FIG. 15;

FIG. 17 illustrates a schematic structural diagram of a microfluidic chip according to an embodiment of the present disclosure;

FIG. 18 illustrates simulation comparison diagrams of the generated droplet, (a) the confluence region of the microfluidic chip has no concave structure; (b) the confluence region of the microfluidic chip has the concave structure illustrated in FIG. 17;

FIG. 19 illustrates a schematic structural diagram of a microfluidic chip according to an embodiment of the present disclosure;

FIG. 20 illustrates simulation comparison diagrams of the generated droplet, (a) the confluence region of the microfluidic chip has no concave structure; (b) the confluence region of the microfluidic chip has the concave structure illustrated in FIG. 19;

FIG. 21 illustrates a schematic structural diagram of a microfluidic chip according to an embodiment of the present disclosure; and

FIG. 22 illustrates a block diagram of a microfluidic device.

### DETAILED DESCRIPTION OF THE DISCLOSURE

The technical solutions in the embodiments of the present disclosure will be clearly described in the following with reference to the drawings. Apparently, the described embodiments are only some, but not all, of the embodiments of the present disclosure. Based on the embodiments in the present disclosure, all other embodiments obtained by those of ordinary skill in the art without undue experimentation belong to the protection scope of the present disclosure.

Microfluidics is a technology that uses the fluid shear force of the continuous phase to destroy the surface tension of the dispersed phase at the microscale, and divides the dispersed phase into nanoliter order or even picoliter order droplets. The microfluidic chip has the advantages of small size, high precision, and complete isolation between droplets, and is an excellent microreactor and has been widely used in fields such as mass spectrometry, gene screening, PCR.

The number, generation rate and consistency of droplets are the key factors affecting the application of droplet microfluidics. With the requirements for the detection accuracy and detection throughput in the biological and medical fields improve, the requirements for the rate and throughput of droplet generation are also getting higher and higher. For digital PCR, its principle is to use the Poisson distribution to calculate the original nucleic acid concentration based on the number of negative and positive droplets. The number of droplets directly affects the detection accuracy and sensitivity of the equipment. The larger the number of droplets, the higher the detection sensitivity.

In order to achieve a higher throughput of droplet generation in the microfluidic chip, in the related art, multiple channels are usually arranged side by side in the plane where the microfluidic chip is located to form an array, and droplets can be generated in each channel, enabling multi-channel preparation of droplets. Although this arrangement can increase the droplet generation rate to a certain extent, since such array is a horizontal array, in order to realize multiple channels arranged side by side, the area of the microfluidic chip needs to be increased accordingly (length×width). However, the microfluidic chip with increased area cannot meet the growing needs for miniaturization and portability.

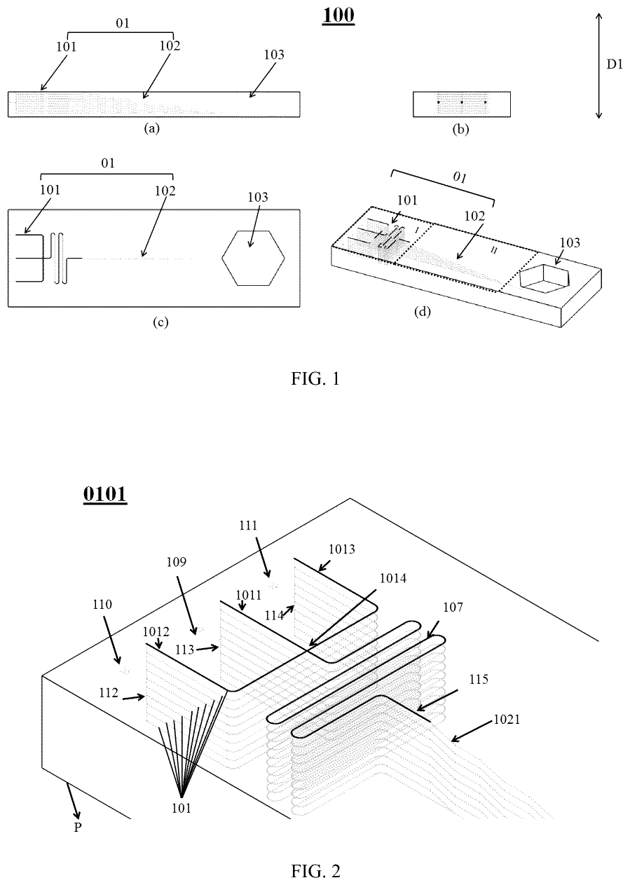

In order to increase the droplet generation rate of the microfluidic chip without increasing the area of the microfluidic chip, embodiments of the present disclosure provide a microfluidic chip. FIG. 1 illustrates a schematic structural diagram of a microfluidic chip 100, in which (a) is a front view of the microfluidic chip 100, (b) is a left view of the microfluidic chip 100, (c) is a top view of the microfluidic chip 100, and (d) is an upper and lower isometric view of the microfluidic chip 100. FIG. 2 illustrates a partial enlarged view of region I of FIG. 1(d). Referring to FIG. 1 and FIG. 2, the microfluidic chip 100 comprises at least two units 01 stacked in a first direction D1 perpendicular to the microfluidic chip 100, and each of the at least two units 01 comprises a generation part 101, the generation part 101 is configured to generate a target fluid.

The target fluid may be any appropriate type of fluid, as long as it can be prepared by the generation part 101. In some embodiments, the target fluid is a droplet, such as a droplet having a water-in-oil structure. For example, the droplet may be a droplet comprising a single cell. For ease of description, the structure of the microfluidic chip 100 is described below by taking the target fluid as droplets as an example, but this does not mean or imply that the target fluid can only be droplets.

At least two (for example M, M≥2) generation parts 101 are stacked in the first direction D1 perpendicular to the microfluidic chip 100, each generation part 101 can generate droplets. Compared with only arranging a single generation part in the horizontal direction of the microfluidic chip, the efficiency of the microfluidic chip 100 in generating droplets is increased by M times, which enables the microfluidic chip 100 to rapidly generate droplets with significantly improved throughput. Moreover, since the generation parts 101 are stacked in the first direction D1 perpendicular to the microfluidic chip 100 instead of being arranged laterally in the horizontal direction of the microfluidic chip 100, even if multiple generation parts 101 are stacked in the first direction D1, the occupied area of the microfluidic chip 100 in the horizontal direction will not be increased, so that the microfluidic chip 100 can meet the requirements of miniaturization and portability.

M may be an appropriate positive integer, for example, M may be 2, 3, 4, 5, 6, 7, 8, 9, 10. In some embodiments, the microfluidic chip 100 comprises 10 units 01 stacked in the first direction D1, and each unit 01 comprises the generation part 101, that is, the microfluidic chip 100 comprises 10 generation parts 101 stacked in the first direction D1, as illustrated in FIG. 1 and FIG. 2. When the value of M is 10, compared with only arranging a single generation part in the horizontal direction of the microfluidic chip, the efficiency of the microfluidic chip 100 in generating droplets is increased by 10 times. However, compared to the conventional microfluidic chip, the area of the microfluidic chip 100 does not change. In some embodiments, the area of the microfluidic chip 100 is 25 mm×75 mm. In some embodiments, in the first direction D1, the thickness of each unit 01 is 0.05 mm, and the distance between any two adjacent units 01 among ten units 01 is 0.5 mm. In some embodiments, the thickness of the microfluidic chip 100 in the first direction D1 is 7 mm. Such a size enables the microfluidic chip 100 to meet the requirements of miniaturization and portability.

FIG. 2 illustrates a stacked structure 0101 comprising ten generation parts 101. Each generation part 101 has the same structure. For the convenience of readers, the specific structure of the generation part 101 may be described by taking the generation part 101 farthest from the bottom surface P of the microfluidic chip 100 in FIG. 2 (i.e., the generation part 101 drawn with a black solid line in FIG. 2) as an example. The specific structures of the generation parts 101 of other units are the same as that of the generation part 101.

The generation part 101 of each unit 01 comprises a first channel 1011 and a second channel 1012 that merge at a confluence region 1014. The first channel 1011 allows the first fluid to flow therein, and the first fluid may be, for example, a dispersed phase (e.g., water phase) fluid. The second channel 1012 allows a second fluid to flow therein, and the second fluid may be, for example, a continuous phase (e.g., oil phase) fluid, which may be, for example, any appropriate fluid such as mineral oil, perfluorinated oil, or the like. The first fluid and the second fluid merge at the confluence region 1014. Under the microscale of the microfluidic chip 100, the shear force of the second fluid of the continuous phase is used to destroy the surface tension of the first fluid of the dispersed phase, thereby the first fluid of the dispersed phase is divided into droplets, for example, droplets having a water-in-oil structure. As illustrated in FIG. 2, the microfluidic chip 100 also comprises a first inlet 109 and a second inlet 110. The first channels 1011 of all units 01 are connected to each other via a first connection channel 113, and the first channels 1011 of all units 01 share the same first inlet 109. The second channels 1012 of all units 01 are connected to each other via a second connection channel 112, and the second channels 1012 of all units 01 share the same second inlet 110. With such an arrangement, when the required fluid needs to be injected into the first channel 1011 and the second channel 1012 of the microfluidic chip 100, only one first driving device is needed to provide the first fluid to all the first channels 1011 (for example, ten stacked first channels 1011) through the first inlet 109, and only one second driving device is needed to provide the second fluid to all the second channels 1012 (for example, ten stacked second channels 1012) through the second inlet 110. In this way, the number of driving devices that are equipped may be greatly reduced, which is more beneficial to the miniaturization and portability of the microfluidic chip 100.

In some embodiments, the generation part 101 of each unit 01 may also comprise a third channel 1013 allowing a third fluid to flow therein. For example, the third fluid may also be the continuous phase (e.g., oil phase) fluid, such as mineral oil, perfluorinated oil, or any other appropriate fluid. In the embodiment in which the generation part 101 comprises a first channel 1011, a second channel 1012 and a third channel 1013, the first channel 1011, the second channel 1012 and the third channel 1013 merge at the confluence region 1014, and the fluids flowing in the three channels merge at the confluence region 1014 and generate droplets, for example, droplets with a water-in-oil structure. In this case, the microfluidic chip 100 further comprises a third inlet 111, the third channels 1013 of all units 01 are connected to each other via a third connection channel 114, and the third channels 1013 of all units 01 share the same third inlet 111. With such an arrangement, when it is necessary to inject the third fluid into the third channel 1013 of the microfluidic chip 100, only one third driving device is needed to provide the third fluid to all third channels 1013 (for example, ten stacked third channels 1013) through the third inlet 111.

It should be noted that in the specification of this application, terms such as “A is connected with B” or “A is communicated with B” may refer to A is directly connected or communicated with B and there is no other element or component between them, or refer to A is connected or communicated with B through one or more intermediate elements or components. Terms such as “A is directly connected with B” or “A is directly communicated with B” mean that A is directly connected or communicated with B, with no other elements or components between them. The terms “connect” and “communicate” may be used interchangeably in this application.

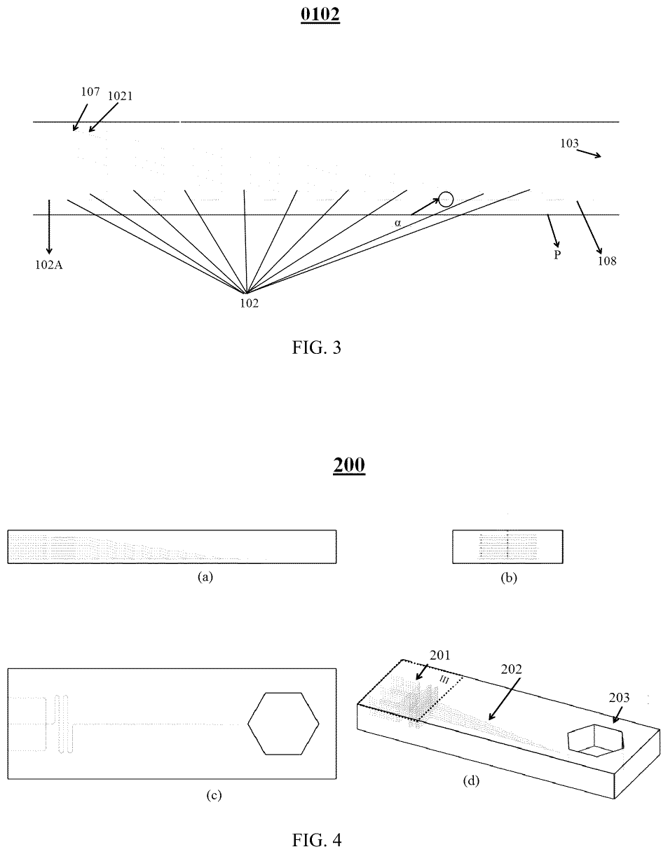

FIG. 3 illustrates a partial enlarged view of region II of FIG. 1(d). Referring to FIG. 1 and FIG. 3, each unit 01 also comprises a delivery channel 102 located downstream of the generation part 101, and the inlet 1021 of the delivery channel 102 of each unit 01 is communicated with the generation part 101. In other words, the droplets generated at the confluence region 1014 of the generation part 101 of each unit 01 flow into the downstream delivery channel 102 along the inlet 1021. FIG. 3 illustrates a stacked structure 0102 comprising ten delivery channels 102. The ten delivery channels 102 comprise a first delivery channel 102 (denoted as 102A) closest to the bottom surface P of the microfluidic chip 100 in the first direction D1 and the remaining nine delivery channels 102, The outlet of each of the remaining nine delivery channels 102 intersects with the first delivery channel 102A respectively. That is, each of the remaining nine delivery channels 102 is directly communicated with the first delivery channel 102A. The first delivery channel 102A comprises a fluid outlet 108, the droplets in each of the remaining nine delivery channels 102 flow into the first delivery channel 102A through the outlet of the respective delivery channel and are merged at the first delivery channel 102A, and these collected droplets flow into the downstream collector through the fluid outlet 108 of the first delivery channel 102A. For the convenience of description, the unit 01 farthest from the bottom surface P of the microfluidic chip 100 is referred to as the tenth unit 01, the generation part 101 and the delivery channel 102 of the tenth unit 01 are referred to as the tenth generation part 101 and the tenth delivery channel 102. The unit 01 that is the second farthest from the bottom surface P of the microfluidic chip 100 is referred to as the ninth unit 01, and the generation part 101 and the delivery channel 102 of the ninth unit 01 are referred to as the ninth generation part 101 and the ninth delivery channel 102. By analogy, the unit 01 closest to the bottom surface P of the microfluidic chip 100 is referred to as the first unit 01, and the generation part 101 and the delivery channel 102 of the first unit 01 are referred to as the first generation part 101 and the first delivery channel 102A. During use of the microfluidic chip 100, the droplets generated at the confluence region 1014 of the tenth generation part 101 flow into the tenth delivery channel 102, and then flow into the first delivery channel 102A through the outlet of the tenth delivery channel 102; the droplets generated at the confluence region 1014 of the ninth generation part 101 flow into the ninth delivery channel 102, and then flow into the first delivery channel 102A through the outlet of the ninth delivery channel 102; the droplets generated at the confluence region 1014 of the eighth generation part 101 flow into the eighth delivery channel 102, and then flow into the first delivery channel 102A through the outlet of the eighth delivery channel 102; the droplets generated at the confluence region 1014 of the seventh generation part 101 flow into the seventh delivery channel 102, and then flow into the first delivery channel 102A through the outlet of the seventh delivery channel 102; the droplets generated at the confluence region 1014 of the sixth generation part 101 flow into the sixth delivery channel 102, and then flow into the first delivery channel 102A through the outlet of the sixth delivery channel 102; the droplets generated at the confluence region 1014 of the fifth generation part 101 flow into the fifth delivery channel 102, and then flow into the first delivery channel 102A through the outlet of the fifth delivery channel 102; the droplets generated at the confluence region 1014 of the fourth generation part 101 flow into the fourth delivery channel 102, and then flow into the first delivery channel 102A through the outlet of the fourth delivery channel 102; the droplets generated at the confluence region 1014 of the third generation part 101 flow into the third delivery channel 102, and then flow into the first delivery channel 102A through the outlet of the third delivery channel 102; the droplets generated at the confluence region 1014 of the second generation part 101 flow into the second delivery channel 102, and then flow into the first delivery channel 102A through the outlet of the second delivery channel 102. Therefore, all droplets in the tenth to the first delivery channels are collected into the first delivery channel 102A, and then flow into the downstream collector 103 via the fluid outlet 108 of the first delivery channel 102A.

As illustrated in FIG. 3, the first delivery channel 102A is arranged parallel to the reference plane where the microfluidic chip 100 is located, and each of the remaining nine delivery channels 102 has a slope relative to the first delivery channel 102A. Such slope design allows the droplets in the remaining nine delivery channels 102 to slowly flow into the first delivery channel 102A along the slope, thereby producing a buffering effect and preventing the droplets from breaking up due to height differences during the flow process, thereby ensuring the stability of the droplets. Therefore, under the synergistic effect of the stacked multiple generation parts 101 and multiple delivery channels 102, the microfluidic chip 100 may achieve high throughput, high speed, high quality, and high stability in preparing and generating droplets. In some embodiments, the slope angle α of each of the remaining delivery channels 102 and the first delivery channel 102A is 10°˜30°.

As illustrated in FIG. 2, each unit 01 may also comprise a buffer channel 107 located between the confluence region 1014 and the delivery channel 102 (or 102A). The buffer channel 107 is designed to have a long channel, so that multiple droplets flowing into the buffer channel 107 from the confluence region 1014 can be dispersed within the length to prevent multiple droplets from merging or breaking up. Each unit 01 may also comprise an extended channel 115 located between the buffer channel 107 and the delivery channel 102. The extended channel 115 may be a horizontal channel parallel to the reference plane where the microfluidic chip 100 is located. The extended channel 115 is directly connected to the inlet 1021 of the delivery channel 102.

As illustrated in FIG. 1, the microfluidic chip 100 further comprises a collector 103 located downstream of the first delivery channel 102A, and the collector 103 is communicated with the fluid outlet 108 of the first delivery channel 102A. Therefore, all the droplets merged at the first delivery channel 102A flow into the collector 103 via the fluid outlet 108 without having to equip each delivery channel with a separate collector, which helps to further improve the miniaturization of the microfluidic chip 100.

In the microfluidic chip 100, by stacking M generation parts 101 in the first direction D1, without increasing the area of the microfluidic chip 100, the efficiency of the microfluidic chip 100 in generating droplets can be increased by M times, so that the microfluidic chip 100 can quickly generate droplets with significantly increased throughput. By making the plurality of remaining delivery channels 102 stacked in the first direction D1 have a slope relative to the first delivery channel 102A, the droplets in the delivery channels 102 can flow into the first delivery channel 102A slowly to prevent the droplets from breaking up due to the height difference during the flow process, thereby ensuring the stability of the droplets.

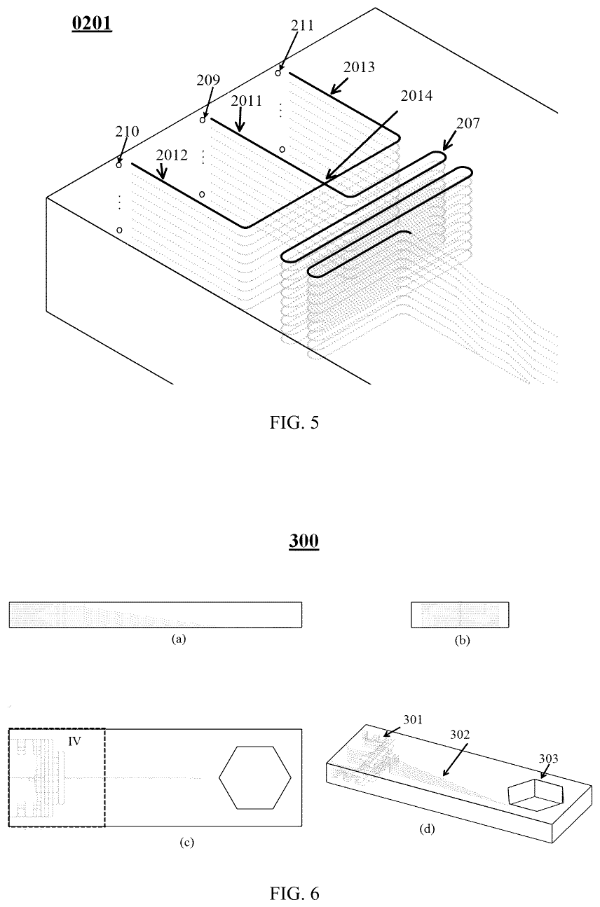

FIG. 4 illustrates a schematic structural diagram of a microfluidic chip 200, where (a) is a front view of the microfluidic chip 200, (b) is a left view of the microfluidic chip 200, (c) is a top view of the microfluidic chip 200, and (d) is an upper and lower isometric view of the microfluidic chip 200. FIG. 5 illustrates an enlarged view of region III of FIG. 4(d). The microfluidic chip 200 has basically the same structure as the microfluidic chip 100 except for the generation part 201. For the sake of brevity, only the differences between the microfluidic chip 200 and the microfluidic chip 100 are described below, and the similarities may be referred to the description of the microfluidic chip 100.

Each unit of the microfluidic chip 200 comprises a generation part 201 and a delivery channel 202, and all droplets in the delivery channel 202 flow into a collector 203 through a unified outlet. The generation part 201 comprises a first channel 2011, a second channel 2012, and a third channel 2013. The first channel 2011, the second channel 2012, and the third channel 2013 merge at the confluence region 2014. The first channel 2011 allows the first fluid to flow therein, and the first fluid may be, for example, a dispersed phase (e.g., water phase) fluid. The second channel 2012 and the third channel 2013 allow the second fluid and the third fluid to flow therein respectively, the second fluid and the third fluid may be, for example, continuous phase (e.g., oil phase) fluids. Different from the microfluidic chip 100, all the first channels 2011 of the microfluidic chip 200 are no longer connected to each other via the connection channel, but each has an independent inlet; all the second channels 2012 of the microfluidic chip 200 are no longer connected to each other via the connection channel, but each has an independent inlet; all the third channels 2013 of the microfluidic chip 200 are no longer connected to each other via the connection channel, but each has an independent inlet. FIG. 5 illustrates ten generation parts 201 stacked in the first direction D1, and the ten generation parts 201 constitute a stacked structure 0201. The first channel 2011 of each generation part 201 is equipped with a separate first inlet 209, for example, the first inlet 209 of the first channel 2011 of the tenth generation part 201 does not communicate with the first inlet 209 of the first channel 2011 of any of the remaining nine generation parts 201. Similarly, the second channel 2012 of each generation part 201 is equipped with a separate second inlet 210, for example, the second inlet 210 of the second channel 2012 of the tenth generation part 201 does not communicate with the second inlet 210 of the second channel 2012 of any of the remaining nine generation parts 201; the third channel 2013 of each generation part 201 is equipped with a separate third inlet 211, for example, the third inlet 211 of the third channel 2013 of the tenth generation part 201 does not communicate with the third inlet 211 of the third channel 2013 of any of the remaining nine generation parts 201.

When using the microfluidic chip 200 to generate droplets, the first channel 2011 of each unit may be connected to an external first driving device via a separate first inlet 209, the second channel 2012 of each unit may be connected to an external second driving device via a separate second inlet 210, and the third channel 2013 of each unit may be connected to an external third driving device via a separate third inlet 211. Therefore, the first driving device may respectively control the flow rate of the first fluid in the stacked ten first channels 2011, the second driving device may respectively control the flow rate of the second fluid in the stacked ten second channels 2012, and the third driving device may respectively control the flow rate of the third fluid in the stacked ten third channels 2013. The flow rate of the fluid is related to the generation rate of droplet, for example, when the flow rate of fluid in the first to third channels of a layer unit is different from the flow rate of fluid in the first to third channels of another layer unit, the generation rates of droplet of two units are also different. Therefore, by controlling the flow rate of fluid in the channels which are in different layers through the driving device, the generation rate of droplets may be controlled by each layer, so that the droplets may be generated more intelligently and efficiently.

Each unit may also comprise a buffer channel 207 between the confluence region 2014 and the delivery channel 202. The buffer channel 207 is designed to have a long channel, so that multiple droplets flowing into the buffer channel 207 from the confluence region 2014 may be dispersed within the length to prevent multiple droplets from merging or breaking up.

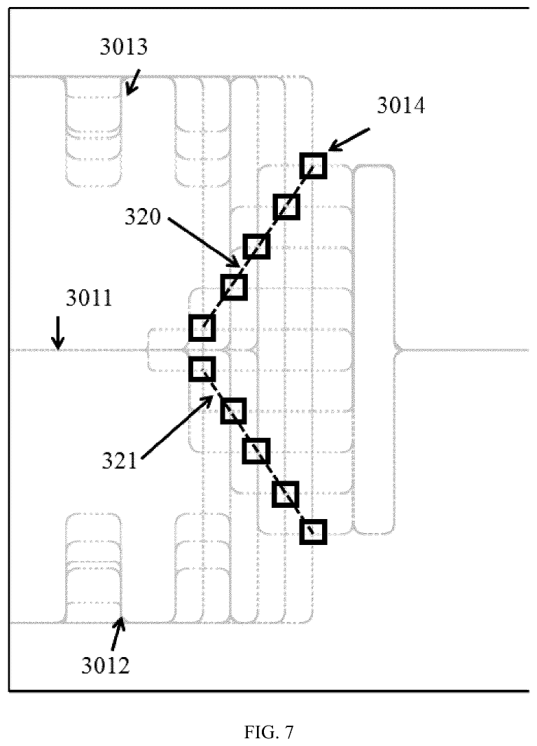

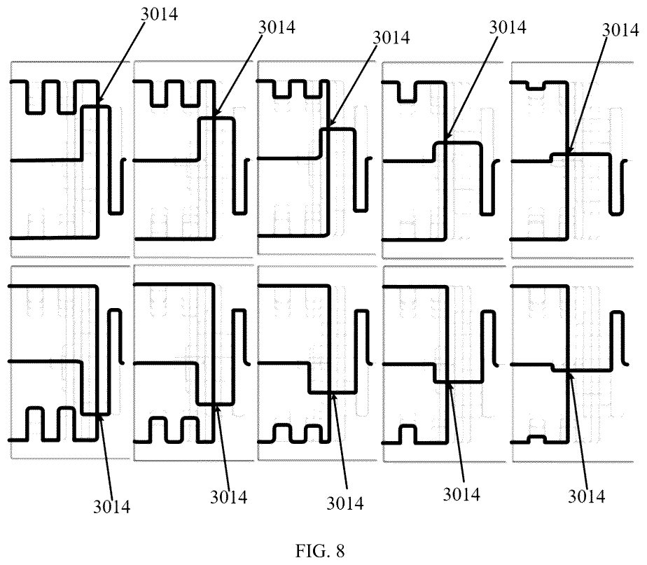

FIG. 6 illustrates a schematic structural diagram of a microfluidic chip 300, in which (a) is a front view of the microfluidic chip 300, (b) is a left view of the microfluidic chip 300, (c) is a top view of the microfluidic chip 300, and (d) is an upper and lower isometric view of the microfluidic chip 300. FIG. 7 illustrates an enlarged view of region IV in FIG. 6(c), and FIG. 8 illustrates a schematic diagram of the channels of the generation part 301 of each unit of the microfluidic chip 300. The microfluidic chip 300 has basically the same structure as the microfluidic chip 100 except for the generation part 301. For the sake of brevity, only the differences between the microfluidic chip 300 and the microfluidic chip 100 are described below, and the similarities may be referred to the description of the microfluidic chip 100.

Each unit of the microfluidic chip 300 comprises a generation part 301 and a delivery channel 302. All droplets in the delivery channels 302 flow into a collector 303 through a unified outlet. The generation part 301 comprises a first channel 3011, a second channel 3012, and a third channel 3013. The first channel 3011, the second channel 3012, and the third channel 3013 merge at the confluence region 3014. The first channel 3011 allows the first fluid to flow therein, and the first fluid may be, for example, the dispersed phase (e.g., water phase) fluid. The second channel 3012 and the third channel 3013 allow the second fluid and the third fluid to flow therein respectively, and the second fluid and the third fluid may be, for example, the continuous phase (e.g., oil phase) fluids.

By designing the arrangement of the first channel 3011, the second channel 3012, and the third channel 3013, the orthographic projections of the confluence regions 3014 of all units on the microfluidic chip 300 do not overlap with each other and do not block each other. Since the confluence regions 3014 of all units do not block each other, the droplet generation at the confluence region 3014 of each unit can be observed through an optical equipment (such as a zoom microscope or a zoom camera), such as the size of the droplet, the generation rate of the droplet, etc., the detection visibility is increased. According to the situation of detection, the driving pressure provided to the microfluidic chip 300 may be adjusted in real time, thereby optimizing the generation rate of droplets and enhancing the maneuverability of droplet generation.

In some embodiments, the microfluidic chip 300 comprises 2N units stacked in the first direction D1, and N is a positive integer. For example, N may be any appropriate positive integer such as 1, 2, 3, 4, 5, 6, etc. In this case, the number of confluence regions 3014 is 2N, the connection line of the orthographic projections of the N confluence regions 3014 among the 2N confluence regions 3014 on the microfluidic chip 300 basically forms a first straight line, the connection line of the orthographic projections of the remaining N confluence regions 3014 among the 2N confluence regions 3014 on the microfluidic chip 300 basically forms a second straight line, the first straight line and the second straight line are axially symmetrical about a symmetry axis. In an example, as illustrated in FIG. 7, the microfluidic chip 300 comprises ten units stacked in the first direction D1, and accordingly, the number of the confluence regions 3014 is also ten. The connection line of the orthographic projections of 5 confluence regions 3014 among the 10 confluence regions 3014 on the microfluidic chip 300 basically forms the first straight line 320, the connection line of the orthographic projections of the remaining 5 confluence regions 3014 among the 10 confluence regions 3014 on the microfluidic chip 300 basically forms the second straight line 321. The first straight line 320 and the second straight line 321 are axially symmetrical about the symmetry axis. In some embodiments, the length of the second channel 3012 is equal to the length of the third channel 3013.

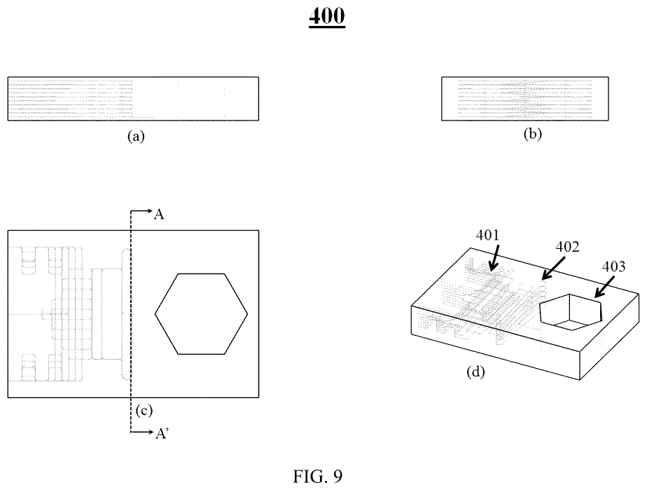

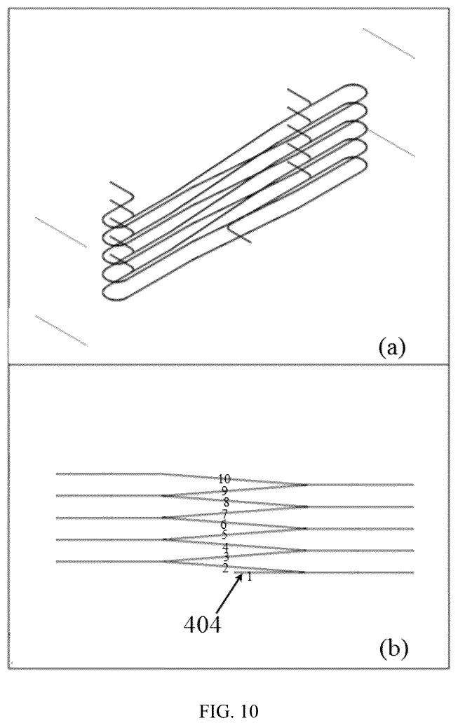

FIG. 9 illustrates a schematic structural diagram of a microfluidic chip 400, in which (a) is a front view of the microfluidic chip 400, (b) is a left view of the microfluidic chip 400, (c) is a top view of the microfluidic chip 400, and (d) is an upper and lower isometric view of the microfluidic chip 400. FIG. 10 illustrates a cross-sectional view along line AA′ of the stacked delivery channels 402 of FIG. 9(c), wherein FIG. 10(a) illustrates an isometric view of the stacked delivery channels 402, and FIG. 10(b) illustrates a right view of the stacked delivery channels 402. In this example, the microfluidic chip 400 is additionally improved based on the microfluidic chip 300, therefore, the microfluidic chip 400 has substantially the same structure as the microfluidic chip 300 except for the stacked delivery channels 402. For the sake of brevity, only the differences between the microfluidic chip 400 and the microfluidic chip 300 are described below, the similarities may be referred to the description of the microfluidic chip 300.

Each unit of the microfluidic chip 400 comprises a generation part 401 and a delivery channel 402. All droplets in the delivery channels 402 are collected into the first delivery channel and flow into the collector 403 through a unified outlet. The microfluidic chip 400 comprises ten units stacked along the first direction D1, the microfluidic chip 400 therefore comprises ten delivery channels 402 stacked along the first direction D1.

Similar to the delivery channel 102, the delivery channel 402 farthest from the bottom surface of the microfluidic chip 400 may be referred to as the tenth delivery channel 402, and the delivery channel 402 closest to the bottom surface of the microfluidic chip 400 may be referred to as the first delivery channel 402. In this order, the ten delivery channels 402 in FIG. 10(b) are marked as “10, 9, 8, 7, 6, 5, 4, 3, 2, 1” respectively. Different from the delivery channels of the previous embodiment, the ten delivery channels 402 of the microfluidic chip 400 are arranged in a spiral manner in the first direction D1, and among these ten delivery channels 402, any two adjacent delivery channels 402 in the first direction D1 are directly connected to each other. In other words, any two adjacent delivery channels among the ten delivery channels 402 are “connected end to end”, for example, the tail outlet of the tenth delivery channel 402 is connected with the beginning inlet of the ninth delivery channel 402, the tail outlet of the ninth delivery channel 402 is connected with the beginning inlet of the eighth delivery channel 402. By analogy, the tail outlet of the second delivery channel 402 is connected with the beginning inlet of the first delivery channel 402. Therefore, in the first direction D1, the arrangement of the ten delivery channels 402 is similar to a “spiral staircase”. The first delivery channel 402 comprises a fluid outlet 404. The droplets in the tenth delivery channel 402 flow through the ninth, eighth, seventh, sixth, fifth, fourth, third, second, and first delivery channels 402 in sequence, and then collect at the fluid outlet 404. The droplets in the ninth delivery channel 402 flow through the eighth, seventh, sixth, fifth, fourth, third, second, and first delivery channels 402 in sequence, and then collect at the fluid outlet 404, and so on. These collected droplets flow into the downstream collector 403 via the fluid outlet 404. It can be seen that in this embodiment, each of the tenth to third delivery channels 402 is in fluid communication with the first delivery channel 402 through several delivery channels in the middle, that is, each of the tenth to third delivery channels 402 is indirectly communicated with the first delivery channel 402, while the second delivery channel 402 is directly communicated with the first delivery channel 402. For example, taking the tenth delivery channel 402 as an example, the tenth delivery channel 402 is in fluid communication with the first delivery channel 402 through the ninth, eighth, seventh, sixth, fifth, fourth, third and second delivery channels 402 in sequence. In the horizontal direction, the shape of each delivery channel 402 may be S-shaped. By designing the stacked delivery channels 402 in a spiral manner, the volume occupied by the delivery channels 402 may be reduced, which is beneficial to reducing the overall volume of the microfluidic chip 400. For example, the overall volume of the microfluidic chip 400 may be reduced to one-half of the conventional volume, which is more in line with the requirements for miniaturization and portability.

It should be noted that although the microfluidic chip 400 is additionally improved based on the microfluidic chip 300, such a design of spiral stacked channels is also applicable to the microfluidic chips 100, 200, and 300 of the previous embodiments and the microfluidic chip 500 introduced later, only their delivery channels need to be replaced by the spiral stacked delivery channels 402.

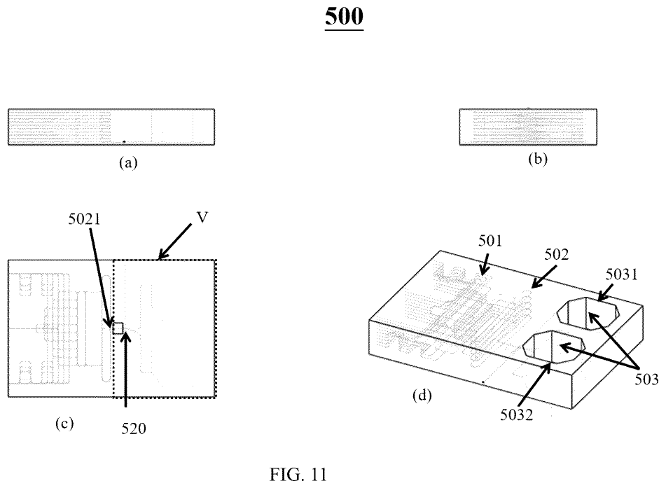

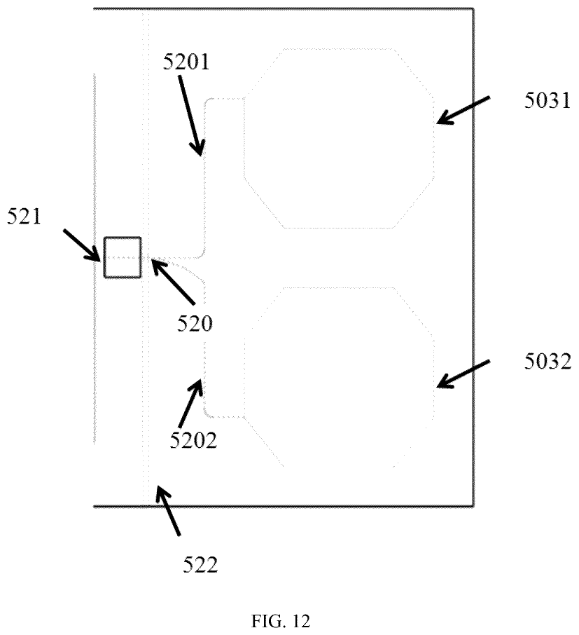

FIG. 11 illustrates a schematic structural diagram of a microfluidic chip 500, where (a) is a front view of the microfluidic chip 500, (b) is a left view of the microfluidic chip 500, (c) is a bottom view of the microfluidic chip 500, and (d) is an upper and lower isometric view of the microfluidic chip 500. FIG. 12 is an enlarged view of the region V in FIG. 11(c). The microfluidic chip 500 is additionally improved based on the microfluidic chip 400, therefore, the microfluidic chip 500 has basically the same structure as the microfluidic chip 400 except for the sorting structure and the collector. For the sake of brevity, only the differences between the microfluidic chip 500 and the microfluidic chip 400 are described below, the similarities may be referred to the description of the microfluidic chip 400.

Each unit of the microfluidic chip 500 comprises a generation part 501 and a delivery channel 502. Droplets in the delivery channels 502 of all units are collected at the fluid outlet 5021 of the first delivery channel 502 (the delivery channel closest to the bottom surface of the microfluidic chip 500). The microfluidic chip 500 further comprises a collector 503 located downstream of the delivery channel 502, the collector 503 comprises two sub-collectors, namely a first sub-collector 5031 and a second sub-collector 5032. The microfluidic chip 500 further comprises a sorting channel 520 located between the fluid outlet 5021 of the first delivery channel 502 and the collector 503, the sorting channel 520 comprises a first sub-sorting channel 5201 and a second sub-sorting channel 5202, the first sub-sorting channel 5201 is communicated with the first sub-collector 5031, and the second sub-sorting channel 5202 is communicated with the second sub-collector 5032. The microfluidic chip 500 may further comprise an electrode 522 and a detection region 521 located between the fluid outlet 5021 of the first delivery channel 502 and the sorting channel 520.

Among the large number of droplets generated by the microfluidic chip 500, there may be some target droplets and some non-target droplets, the target droplet encapsulates the target cells (such as cancer cells) that wish to be studied, and it is hoped that the target droplets can be sorted from the large number of droplets for subsequent research and detection.

The microfluidic chip 500 may achieve the sorting function of target droplets through the following method.

The generated droplets are collected at the fluid outlet 5021 of the first delivery channel 502. When the droplets flow from the fluid outlet 5021 to the detection region 521, an optical equipment (such as a microscope or camera) is used to perform fluorescent detection on each droplet flowing through the detection region 521 and determine the attributes of the droplet. When it is determined that the droplet flowing through the detection region 521 is the target droplet, a signal is immediately fed back to the controller, and the controller immediately applies an appropriate instantaneous voltage to the electrode 522. The target droplet is deflected by the dielectrophoretic force under the electric field and deflected into the first sub-sorting channel 5201, and then flow into the first sub-collector 5031 via the first sub-sorting channel 5201. When it is determined that the droplet flowing through the detection region 521 is the non-target droplet, a signal may or may not be fed back to the controller, and the controller does not apply an instantaneous voltage to the electrode 522. The non-target droplet is deflected into the second sub-sorting channel 5202 under the inertial force, and then flow into the second sub-collector 5032 via the second sub-sorting channel 5202.

By providing the sorting channel 520 with the microfluidic chip 500, the microfluidic chip 500 can not only realize high-throughput droplet generation, but also realize the function of droplet sorting.

It should be noted that although it is only illustrated as an example that the sorting channel 520 is comprised by the microfluidic chip 500, the sorting channel 520 (and the related detection region 521 and the electrode 522, etc.) is also suitable for the microfluidic chips 100, 200, 300, and 400 described in the previous embodiments, so that the microfluidic chips 100, 200, 300, and 400 also have the functions of high-throughput droplet generation and droplet sorting.

In order to further improve the droplet generation rate and throughput, the inventor(s) further optimized the confluence region of the channel of the microfluidic chip. In the optimization solution, the microfluidic chip may comprise two channels, namely the first channel and the second channel as mentioned above; or, may also comprise three channels, namely the first channel, the second channel, and the third channel as mentioned above. At least one of the first channel and the second channel includes at least one concave structure at the confluence region, the size of the first channel or the second channel comprising the concave structure at the confluence region is smaller than the size of the channel at the non-confluence region, the non-confluence region refers to other regions of the first channel or the second channel other than the confluence region. The introduction of the concave structure at the confluence region will narrow the channel there, thereby increasing the flow rate of the fluid at the confluence region. Therefore, without changing the fluid injection speed at the inlet of the channel, the droplet generation rate can be accelerated by introducing the concave structure at the confluence region, which allows more droplets to be quickly generated within the same period of time, improving the generation efficiency and throughput of droplets.

The following describes how to increase the generation rate of droplets by introducing a concave structure at the confluence region through several specific embodiments.

FIG. 13 illustrates a schematic structural diagram of a microfluidic chip 600. The microfluidic chip 600 may be any one of the microfluidic chips 100, 200, 300, 400, and 500 described in the previous embodiments when comprising two channels. For the sake of brevity, only a unit in a single layer is illustrated in the figure, and stacked other units are omitted. As illustrated in the figure, the microfluidic chip 600 comprises a first channel 601, a second channel 602 and a collector 603. The first channel 601 and the second channel 602 merge at the confluence 604. The first channel 601 and the second channel 602 form a “T-shaped channel” at the confluence region 604. The first channel 601 allows the first fluid to flow therein, and the first fluid may be the dispersed phase fluid. The second channel 602 allows the second fluid to flow therein, and the second fluid may be the continuous phase fluid. The first fluid and the second fluid merge at the confluence region 604 to generate droplets.

The upper right part in FIG. 13 is a partial enlarged view of the part in the dotted circle at the lower left. As illustrated in the figure, the non-confluence region R of the first channel 601 has a first width W1 along a second direction D2, the non-confluence region R of the second channel 602 has a second width W2 along a third direction D3, the second direction D2 and the third direction D3 are substantially perpendicular to each other and located in a reference plane parallel to the microfluidic chip 600. As defined herein, the non-confluence region R refers to other regions of the first channel 601 or the second channel 602 except the confluence region 604. For example, the non-confluence region R of the first channel 601 refers to other regions of the first channel 601 except the confluence region 604, and only a part of the non-confluence region R of the first channel 601 is marked in the figure. The non-confluence region R of the second channel 602 refers to other regions of the second channel 602 except the confluence region 604.

The first channel 601 comprises two symmetrical concave structures 605 located at the T-shaped confluence region 604, that is, the two symmetrical concave structures 605 are located at the outlet of the first channel 601 at the confluence region 604. In this application, the term “concave structure” means that the outer surface of the structure is closer to the centerline of the channel relative to the outer surface of the channel to which the concave structure belongs. As a result, the outer surface of the channel takes on a “concave” shape where the concave structure is located. The shape of the concave structure may be any suitable shape, comprising but not limited to rectangular, conical, trapezoidal, etc.

The ratio of the width W of each of the two symmetrical concave structures 605 along the second direction D2 to the first width W1 is ⅙ to ⅓, for example, the ratio may be ⅙, ¼, ⅓, and so on, and the height H of each of the two symmetrical concave structures 605 along the third direction D3 is equal to the second width W2. In an embodiment, the width W of each of the two symmetrical concave structures 605 along the second direction D2 is ¼ of the first width W1, and the height H of each of the two symmetrical concave structures 605 along the third direction D3 is equal to the second width W2. Since the concave structure 605 is introduced at the confluence region 604 of the first channel 601, the width W0 of the first channel 601 at the confluence region 604 is smaller than the first width W1 of the first channel 601 at the non-confluence region R. In this example, W0=(W1)/2.

FIG. 14 illustrates simulation comparison diagrams of the generated droplet, in which (a) is the generation rate of a droplet corresponding to the confluence region of the microfluidic chip that does not comprise a concave structure (a reference experiment); (b) is the generation rate of a droplet of the microfluidic chip 600. As illustrated in FIG. 14(a), the time of generating the first droplet is 0.030 s, the time of generating the second droplet is 0.044 s, the time of generating the third droplet is 0.058 s, and the time of generating the fourth droplet is 0.071 s. The time interval between generating the second droplet and the first droplet is 0.014 s, the time interval between generating the third droplet and the second droplet is 0.014 s, and the time interval between generating the fourth droplet and the third droplet is 0.013 s. Therefore, in the microfluidic chip without a concave structure, the generation rate of a droplet is approximately 14 ms/droplet. After measurement, the diameter of the generated droplet is approximately 0.111 mm. As illustrated in FIG. 14(b), the time of generating the first droplet is 0.023 s, the time of generating the second droplet is 0.036 s, the time of generating the third droplet is 0.048 s, and the time of generating the fourth droplet is 0.060 s. The time interval between generating the second droplet and the first droplet is 0.013 s, the time interval between generating the third droplet and the second droplet is 0.012 s, and the time interval between generating the fourth droplet and the third droplet is 0.012 s. Therefore, in the microfluidic chip 600 with the concave structure 605, the generation rate of a droplet is approximately 12 ms/droplet. After measurement, the diameter of the generated droplet is approximately 0.109 mm. It can be seen from the above data that compared with not introducing the concave structure, the generation rate of a droplet is increased by 14.3% and the diameter of a droplet is reduced by 1.8% by introducing the concave structure 605 at the confluence region 604.

By introducing the concave structure 605 at the confluence region 604, the width of the confluence region 604 of the first channel 601 in the second direction D2 is narrowed, so that the flow rate of the first fluid flowing the confluence region 604 becomes larger. Thus, the rate at which the second fluid in the continuous phase shears the first fluid in the dispersed phase is accelerated, the first fluid in the dispersed phase can be divided into droplets more quickly. Therefore, the generation rate of droplet can be increased, more droplets are generated in the same time, and the generation efficiency and throughput of droplets are improved. Without changing the injection speed of the first fluid at the inlet of the first channel 601, the generation rate of droplet is increased. Moreover, it can be seen from the simulation data that although the generation rate of a droplet is increased by 14.3% compared with not introducing the concave structure 605, the change in diameter of a droplet is relatively small, so the microfluidic chip 600 does not significantly affect the size of the generated droplet and does not destroy the stability of the droplets.

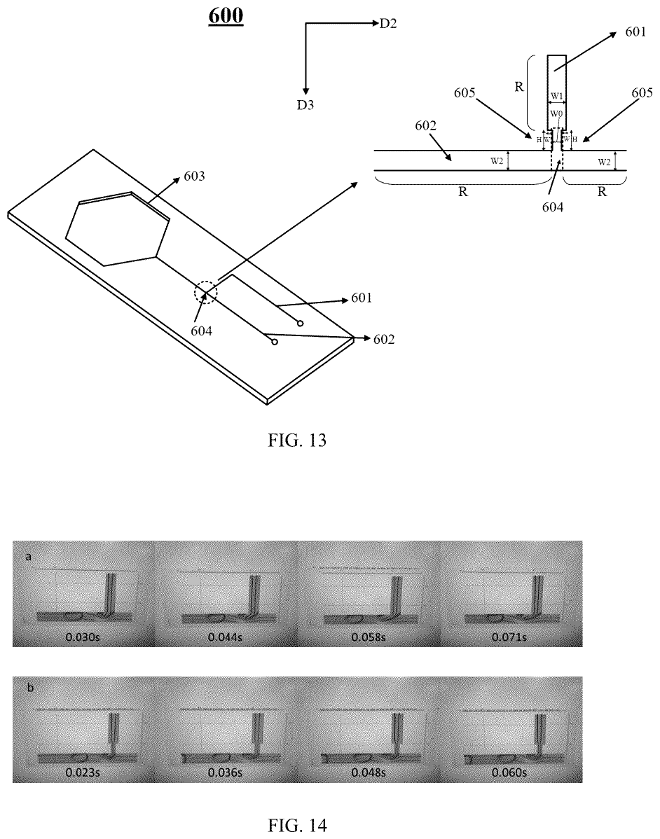

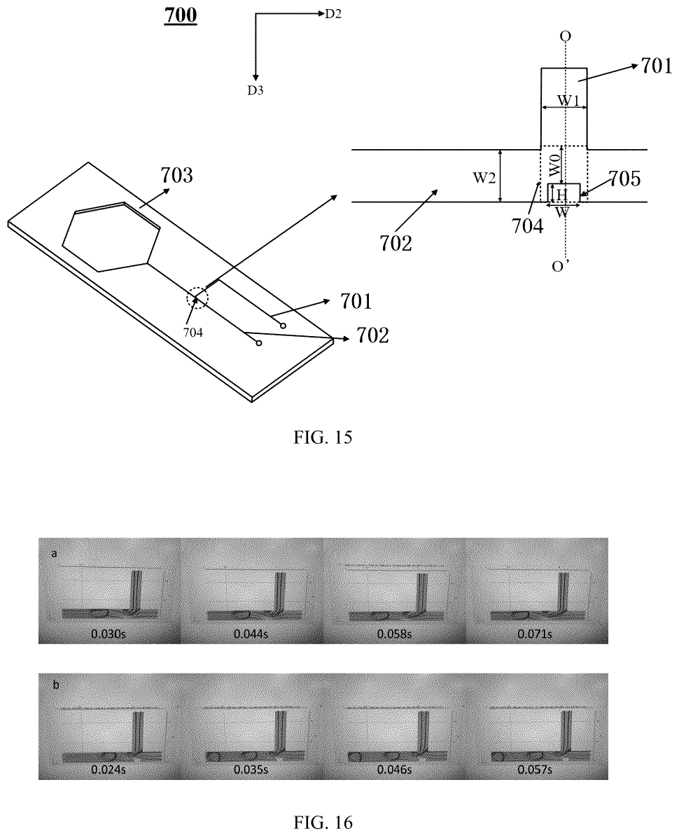

FIG. 15 illustrates a schematic structural diagram of a microfluidic chip 700. The microfluidic chip 700 may be any one of the microfluidic chips 100, 200, 300, 400, and 500 described in the previous embodiments when comprising two channels. For the sake of brevity, only a unit in a single layer is illustrated in the figure, and stacked other units are omitted. As illustrated in the figure, the microfluidic chip 700 comprises a first channel 701, a second channel 702, and a collector 703. The first channel 701 and the second channel 702 merge at the confluence region 704. At the confluence region 704, the first channel 701 and the second channel 702 form a “T-shaped channel”. The first channel 701 allows the first fluid to flow therein, and the first fluid may be the dispersed phase fluid. The second channel 702 allows the second fluid to flow therein, and the second fluid may be the continuous phase fluid. The first fluid and the second fluid merge at confluence region 704 to generate droplets. The first channel 701 has a first width W1 along the second direction D2 at the non-confluence region, and the second channel 702 has a second width W2 along the third direction D3 at the non-confluence region R.

The upper right part in FIG. 15 is a partial enlarged view of the part in the dotted circle at the lower left. As illustrated in the figure, the second channel 702 comprises a concave structure 705 located at the confluence region 704. The ratio of the width W of the concave structure 705 along the second direction D2 to the first width W1 is ⅓ to ⅔, for example, the ratio may be ⅓, ½, ⅔, etc., and the ratio of the height H of the concave structure 705 along the third direction D3 to the second width W2 is ¼ to ½, for example, the ratio may be ¼, ⅓, ½, etc. In an embodiment, the width W of the concave structure 705 along the second direction D2 is ⅔ of the first width W1, the height H of the concave structure 705 along the third direction D3 is ⅓ of the second width W2, and correspondingly, the width W0 of the second channel 702 at the confluence region 704 is equal to ⅔ of the second width W2. As illustrated in the figure, the center line OO′ of the concave structure 705 along the third direction D3 coincides with the center line OO′ of the first channel 701 along the third direction D3. Therefore, the center of the concave structure 705 aligns with the center of the first channel 701.

FIG. 16 illustrates simulation comparison diagrams of the generated droplet, in which (a) is the generation rate of a droplet corresponding to the confluence region of the microfluidic chip that does not comprise a concave structure (a reference experiment); (b) is the generation rate of a droplet corresponding to the microfluidic chip 700. The data in FIG. 16(a) is exactly the same as the data in FIG. 14(a), that is, in a microfluidic chip without a concave structure, the generation rate of a droplet is about 14 ms/droplet, and the diameter of the generated droplet is about 0.111 mm. As illustrated in FIG. 16(b), the time of generating the first droplet is 0.024 s, the time of generating the second droplet is 0.035 s, the time of generating the third droplet is 0.046 s, and the time of generating the fourth droplet is 0.057 s. The time interval between generating the second droplet and the first droplet is 0.011 s, the time interval between generating the third droplet and the second droplet is 0.011 s, and the time interval between generating the fourth droplet and the third droplet is 0.011 s. Therefore, in the microfluidic chip 700 with the concave structure 705, the generation rate of a droplet is approximately 11 ms/droplet. After measurement, the diameter of the generated droplet is approximately 0.108 mm. It can be seen from the above data that compared with not introducing the concave structure, the generation rate of a droplet is increased by 21.4% and the diameter of a droplet is reduced by 2.7% when the concave structure 705 is introduced at the confluence region 704.

Compared with the microfluidic chip 600, the generation rate of the droplet of the microfluidic chip 700 is further increased, and the diameter of the generated droplet is slightly reduced, but the difference is within 3%. Compared with providing the concave structure 605 at the confluence region 604 of the first channel 601, by providing the concave structure 705 at the confluence region 704 of the second channel 702, the shear force of the continuous phase second fluid may be further increased. As a result, the dispersed phase first fluid may be sheared more quickly, so that the first fluid can be divided into droplets more quickly, further increasing the generation rate of droplets.

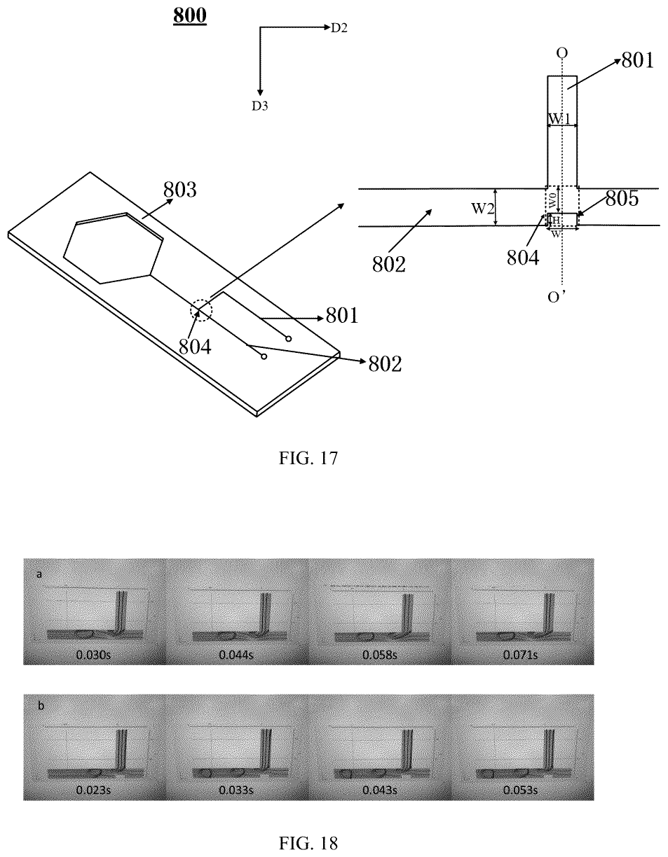

FIG. 17 illustrates a schematic structural diagram of a microfluidic chip 800. The microfluidic chip 800 may be any one of the microfluidic chips 100, 200, 300, 400, and 500 described in the previous embodiments when comprising two channels. For the sake of brevity, only a unit in a single layer is illustrated in the figure, and stacked other units are omitted. As illustrated in the figure, the microfluidic chip 800 comprises a first channel 801, a second channel 802, and a collector 803. The first channel 801 and the second channel 802 merge at the confluence region 804. At the confluence region 804, the first channel 801 and the second channel 802 form a “T-shaped channel”. The first channel 801 allows the first fluid to flow therein, and the first fluid may be the dispersed phase fluid. The second channel 802 allows the second fluid to flow therein, and the second fluid may be the continuous phase fluid. The first fluid and the second fluid merge at the confluence region 804 to generate droplets. The first channel 801 has a first width W1 along the second direction D2 at the non-confluence region, and the second channel 802 has a second width W2 along the third direction D3 at the non-confluence region R.

The upper right part in FIG. 17 is a partial enlarged view of the part in the dotted circle at the lower left. As illustrated in the figure, the second channel 802 comprises a concave structure 805 located at the confluence region 804. The width W of the concave structure 805 along the second direction D2 is equal to the first width W1, and the ratio of the height H of the concave structure 805 along the third direction D3 to the second width W2 is ¼ to ½, for example, the ratio may be ¼, ⅓, ½, etc. In an embodiment, the width W of the concave structure 805 along the second direction D2 is equal to the first width W1, and the height H of the concave structure 805 along the third direction D3 is ⅓ of the second width W2, and correspondingly, the width W0 of the second channel 802 at the confluence region 804 is equal to ⅔ of the second width W2. As illustrated in the figure, the center line OO′ of the concave structure 805 along the third direction D3 coincides with the center line OO′ of the first channel 801 along the third direction D3. Therefore, the center of the concave structure 805 aligns with the center of the first channel 801.

FIG. 18 illustrates simulation comparison diagrams of the generated droplet, in which (a) is the generation rate of a droplet corresponding to the confluence region of the microfluidic chip that does not comprise a concave structure (a reference experiment); (b) is the generation rate of a droplet corresponding to the microfluidic chip 800. The data in FIG. 18(a) is exactly the same as the data in FIG. 14(a), that is, in a microfluidic chip without a concave structure, the generation rate of a droplet is about 14 ms/droplet, and the diameter of the generated droplet is about 0.111 mm. As illustrated in FIG. 18(b), the time of generating the first droplet is 0.023 s, the time of generating the second droplet is 0.033 s, the time of generating the third droplet is 0.043 s, and the time of generating the fourth droplet is 0.053 s. The time interval between generating the second droplet and the first droplet is 0.010 s, the time interval between generating the third droplet and the second droplet is 0.010 s, and the time interval between generating the fourth droplet and the third droplet is 0.010 s. Therefore, in the microfluidic chip 800 with the concave structure 805, the generation rate of a droplet is approximately 10 ms/droplet. After measurement, the diameter of the generated droplet is approximately 0.104 mm. It can be seen from the above data that compared with not introducing the concave structure, the generation rate of a droplet is increased by 28.6% and the diameter of a droplet is reduced by 6.3% when the concave structure 805 is introduced at the confluence region 804.

The difference between microfluidic chip 800 and microfluidic chip 700 is that, the width W of the concave structure 805 along the second direction D2 is equal to the first width W1, while the width W of the concave structure 705 along the second direction D2 is ⅔ of the first width W1. Compared with the microfluidic chip 700, by increasing the width W of the concave structure 805 along the second direction D2, the generation rate of a droplet can be further increased and the diameter of the droplet can be reduced.

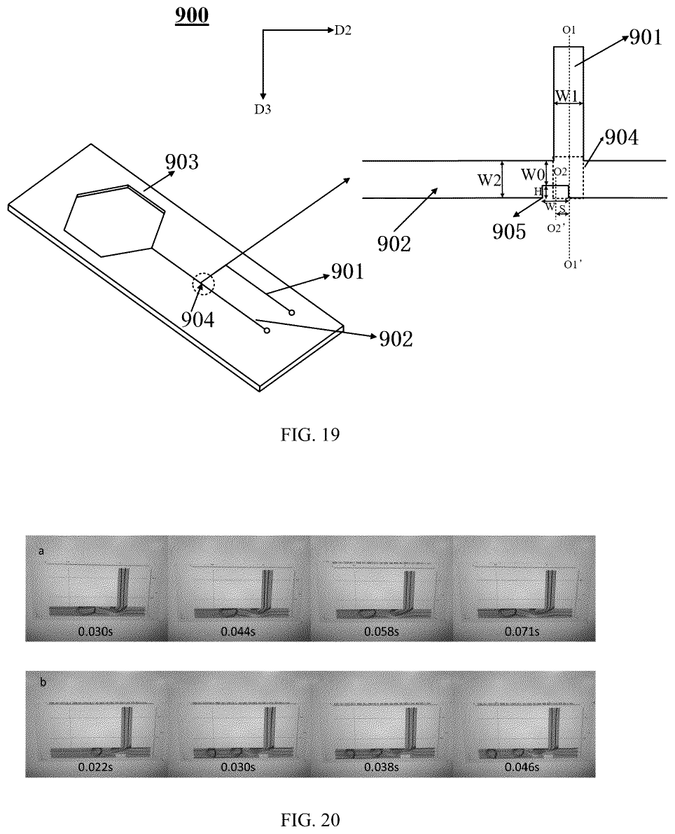

FIG. 19 illustrates a schematic structural diagram of a microfluidic chip 900. The microfluidic chip 900 may be any one of the microfluidic chips 100, 200, 300, 400, and 500 described in the previous embodiments when comprising two channels. For the sake of brevity, only a unit in a single layer is illustrated in the figure, and stacked other units are omitted. As illustrated in the figure, the microfluidic chip 900 comprises a first channel 901, a second channel 902, and a collector 903. The first channel 901 and the second channel 902 merge at the confluence region 904. At the confluence region 904, the first channel 901 and the second channel 902 form a “T-shaped channel”. The first channel 901 allows the first fluid to flow therein, and the first fluid may be the dispersed phase fluid. The second channel 902 allows the second fluid to flow therein, and the second fluid may be the continuous phase fluid. The first fluid and the second fluid merge at the confluence region 904 to generate droplets. The first channel 901 has a first width W1 along the second direction D2 at the non-confluence region, and the second channel 902 has a second width W2 along the third direction D3 at the non-confluence region R.

The upper right part in FIG. 19 is a partial enlarged view of the part in the dotted circle at the lower left. As illustrated in the figure, the second channel 902 comprises a concave structure 905 located at the confluence region 904, the width W of the concave structure 905 along the second direction D2 is equal to the first width W1, and the ratio of the height H of the concave structure 905 along the third direction D3 to the second width W2 is ¼ to ½, for example, the ratio may be ¼, ⅓, ½, etc. In an embodiment, the width W of the concave structure 905 along the second direction D2 is equal to the first width W1, the height H of the concave structure 905 along the third direction D3 is ⅓ of the second width W2, and correspondingly, the width W0 of the second channel 902 at the confluence region 904 is equal to ⅔ of the second width W2. As illustrated in the figure, the centerline 0202′ of the concave structure 905 along the third direction D3 is offset in the second direction D2 relative to the centerline 0101′ of the first channel 901 along the third direction D3, the ratio of the offset distance S to the first width W1 is ⅓ to 1, for example, the ratio may be ⅓, ⅔, ½, 1, etc. As illustrated in the figure, the centerline 0202′ is closer to the collector 903 in the second direction D2 relative to the centerline 0101′.

FIG. 20 illustrates simulation comparison diagrams of the generated droplet, in which (a) is the generation rate of a droplet corresponding to the confluence region of the microfluidic chip that does not comprise a concave structure (a reference experiment); (b) is the generation rate of a droplet corresponding to the microfluidic chip 900. The data in FIG. 20(a) is exactly the same as the data in FIG. 14(a), that is, in a microfluidic chip without a concave structure, the generation rate of a droplet is about 14 ms/droplet, and the diameter of the generated droplet is about 0.111 mm. As illustrated in FIG. 20(b), the time of generating the first droplet is 0.022 s, the time of generating the second droplet is 0.030 s, the time of generating the third droplet is 0.038 s, and the time of generating the fourth droplet is 0.046 s. The time interval between generating the second droplet and the first droplet is 0.008 s, the time interval between generating the third droplet and the second droplet is 0.008 s, and the time interval between generating the fourth droplet and the third droplet is 0.008 s. Therefore, in the microfluidic chip 900 with the concave structure 905, the generation rate of a droplet is approximately 8 ms/droplet. After measurement, the diameter of the generated droplet is approximately 0.117 mm. It can be seen from the above data that compared with not introducing a concave structure, the generation rate of a droplet is increased by 42.9% but the diameter of a droplet is increased by 5.4% when the concave structure 905 is introduced at the confluence region 904.

The difference between the microfluidic chip 900 and the microfluidic chip 800 is that, the centerline 0202′ of the concave structure 905 is offset (W1)/2 in the second direction D2 towards the collector 903 relative to the centerline 0101′ of the first channel 901, while the centerline OO′ of the concave structure 805 coincides with the centerline OO′ of the first channel 801. Compared with the microfluidic chip 800, by staggering the center of the concave structure 905 from the center of the first channel 901 and making the center of the concave structure 905 closer to the collector 903, the shear force of the continuous phase second fluid may be further increased. As a result, the dispersed phase first fluid can be sheared more quickly and divided into droplets, thereby further increasing the generation rate of droplets.

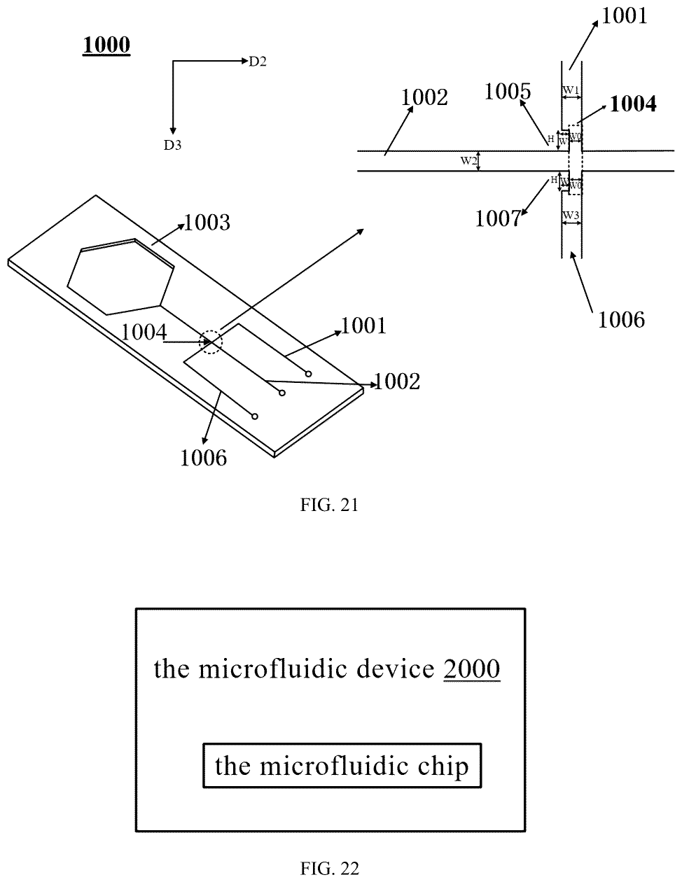

FIG. 21 illustrates a schematic structural diagram of a microfluidic chip 1000. The microfluidic chip 1000 may be any one of the microfluidic chips 100, 200, 300, 400, and 500 described in the previous embodiments when comprising three channels. For the sake of brevity, only a unit in a single layer is illustrated in the figure, and stacked other units are omitted. As illustrated in the figure, the microfluidic chip 1000 comprises a first channel 1001, a second channel 1002, a third channel 1006 and a collector 1003. The second channel 1002 is located between the first channel 1001 and the third channel 1006, and the first channel 1001, the second channel 1002, and the third channel 1006 merge at the confluence region 1004. At the confluence region 1004, the first channel 1001, the second channel 1002, and the third channel 1006 form a “cross-shaped channel”. The second channel 1002 allows the first fluid to flow therein, and the first fluid may be the dispersed phase fluid. The first channel 1001 and the third channel 1006 allow the second fluid to flow therein, and the second fluid may be the continuous phase fluid. The first fluid and the second fluid merge at the confluence region 1004 to generate droplets. The first channel 1001 has a first width W1 along the second direction D2 at the non-confluence region, the third channel 1006 has a third width W3 along the second direction D2 at the non-confluence region, W3=W1, and the second channel 1002 has a second width W2 along the third direction D3 at the non-confluence region.

The upper right part in FIG. 21 is a partial enlarged view of the part in the dotted circle at the lower left. As illustrated in the figure, the first channel 1001 comprises a first concave structure 1005 located at the confluence region 1004, and the third channel 1006 comprises a second concave structure 1007 located at the confluence region 1004. The first concave structure 1005 and the second concave structure 1007 are symmetrical about the second channel 1002, that is, the first concave structure 1005 and the second concave structure 1007 have the same shape and size. The ratio of the width W of each of the first concave structure 1005 and the second concave structure 1007 along the second direction D2 to the first width W1 is ¼ to ½, for example, the ratio may be ¼, ⅓, ½, etc., and the height H of each of the first concave structure 1005 and the second concave structure 1007 along the third direction D3 is equal to the second width W2. It can be inferred from the simulation results of droplet generation in the previous embodiments that, compared with not introducing a concave structure at the confluence region, the concave structures 1005 and 1007 respectively introduced at the cross-shaped confluence region 1004 of the first channel 1001 and the third channel 1006 can significantly increase the generation rate of droplet, and a change of the diameter of the droplet does not exceed 5%.

According to another aspect of the present disclosure, a microfluidic device is provided. FIG. 22 illustrates a block diagram of the microfluidic device 2000. The microfluidic device 2000 comprises the microfluidic chip described in any of the previous embodiments. The microfluidic device 2000 may have substantially the same technical effects as the microfluidic chip described in the previous embodiments. Therefore, for the purpose of simplicity, the technical effects of the microfluidic device 2000 will not be repeated here.

It will be understood that although the terms first, second, third, etc. may be used herein to describe various elements, components, regions, layers and/or portions, these elements, components, regions, layers and/or portions should not be limited by these terms. These terms are only used to distinguish an element, component, region, layer or portion from another element, component, region, layer or portion. Thus, a first element, component, region, layer or portion discussed above could be termed a second element, component, region, layer or portion without departing from the teachings of the present disclosure.

Spatially relative terms such as “row”, “column”, “below”, “above”, “left”, “right”, etc. may be used herein for ease of description to describe factors such as the relationship of an element or feature to another element(s) or feature(s) illustrated in the figures. It will be understood that these spatially relative terms are intended to encompass different orientations of the device in use or operation in addition to the orientation depicted in the figures. For example, if the device in the figures is turned over, elements described as “below” other elements or features would then be oriented “above” other elements or features. Thus, the exemplary term “below” can encompass both an orientation of above and below. The device may be otherwise oriented (rotated 90 degrees or at other orientations) and the spatially relative descriptors used herein are interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to limit the present disclosure. As used herein, the singular forms “a,” “an,” and “the” are intended to comprise the plural forms as well, unless the context clearly dictates otherwise. It will be further understood that the terms “comprise” and/or “include” when used in this specification designate the presence of stated features, integers, steps, operations, elements and/or parts, but do not exclude the presence or addition of one or more other features, integers, steps, operations, elements, components and/or groups thereof. As used herein, the term “and/or” comprises any and all combinations of one or more of the associated listed items. In the description of this specification, description with reference to the terms “an embodiment,” “another embodiment,” etc. means that a particular feature, structure, material, or characteristic described in connection with the embodiment is included in at least one embodiment of the present disclosure. In this specification, schematic representations of the above terms are not necessarily directed to the same embodiment or example. Furthermore, the particular features, structures, materials or characteristics described may be combined in any suitable manner in any one or more embodiments or examples. Furthermore, those skilled in the art may combine the different embodiments or examples as well as the features of the different embodiments or examples described in this specification without conflicting each other.

It will be understood that when an element or layer is referred to as being “on”, “connected to”, “coupled to”, or “adjacent to” another element or layer, it may be directly on, directly connected to, directly coupled to, or directly adjacent to another element or layer, or intervening elements or layers may be present. In contrast, when an element is referred to as being “directly on”, “directly connected to”, “directly coupled to”, “directly adjacent to” another element or layer, with no intervening elements or layers present. However, in no case should “on” or “directly on” be interpreted as requiring a layer to completely cover the layer below.

Embodiments of the disclosure are described herein with reference to schematic illustrations (and intermediate structures) of idealized embodiments of the disclosure. As such, variations to the shapes of the illustrations are to be expected, e.g., as a result of manufacturing techniques and/or tolerances. Accordingly, embodiments of the present disclosure should not be construed as limited to the particular shapes of the regions illustrated herein, but are to comprise deviations in shapes due, for example, to manufacturing. Thus, the regions illustrated in the figures are schematic in nature and their shapes are not intended to illustrate the actual shape of a region of a device and are not intended to limit the scope of the present disclosure.

Unless otherwise defined, all terms (comprising technical and scientific terms) used herein have the same meaning as commonly understood by one of ordinary skill in the art to which this disclosure belongs. It will be further understood that terms such as those defined in commonly used dictionaries should be construed to have meanings consistent with their meanings in the relevant art and/or the context of this specification, and will not be idealized or overly interpreted in a formal sense, unless expressly defined as such herein.

The above descriptions are merely specific embodiments of the present disclosure, but the protection scope of the present disclosure is not limited thereto. Any changes or substitutions that those skilled in the art can easily think of within the technical scope disclosed by the present disclosure, should be comprised within the protection scope of the present disclosure. Therefore, the protection scope of the present disclosure should be based on the protection scope of the claims.

1. A microfluidic chip comprising at least two units stacked in a first direction perpendicular to the microfluidic chip, wherein each of the at least two units comprises a generation part configured to generate a target fluid.

2. The microfluidic chip according to claim 1,
wherein each unit further comprises a delivery channel downstream of the generation part, an inlet of the delivery channel of each unit is in communication with the generation part, and
wherein the delivery channels of all units comprise a first delivery channel closest to a bottom surface of the microfluidic chip in the first direction and remaining delivery channels, each of the remaining delivery channels is in direct or indirect communication with the first delivery channel, and the first delivery channel comprises a fluid outlet.

3. (canceled)

4. The microfluidic chip according to claim 2, further comprising a first inlet and a second inlet,
wherein the generation part of each unit comprises a first channel and a second channel which merge at a confluence region,
wherein the first channels of all units communicate with each other via a first connection channel, and the first channels of all units share the first inlet; and
wherein the second channels of all units communicate with each other via a second connection channel, and the second channels of all units share the second inlet.

5. The microfluidic chip according to claim 2, further comprising at least two first inlets and at least two second inlets respectively corresponding to the at least two units one by one,
wherein the generation part of each unit comprises a first channel and a second channel which merge at a confluence region,
wherein the first channel of each of the at least two units corresponds to a respective one of the at least two first inlets; and
wherein the second channel of each of the at least two units corresponds to a respective one of the at least two second inlets.

6. The microfluidic chip according to claim 2,
wherein the microfluidic chip comprises 2N units stacked in the first direction, where N is a positive integer, the generation part of each unit comprises a first channel and a second channel which merge at a confluence region,
wherein orthographic projections of confluence regions of all units on the microfluidic chip do not overlap with each other, and
wherein a number of the confluence regions is 2N, a connection line of orthographic projections of N confluence regions among the 2N confluence regions on the microfluidic chip basically forms a first straight line, a connection line of orthographic projections of remaining N confluence regions among the 2N confluence regions on the microfluidic chip basically forms a second straight line, and the first straight line and the second straight line are axisymmetric with respect to a symmetrical axis.

7. (canceled)

8. (canceled)

9. The microfluidic chip according to claim 2,
wherein an outlet of each of the remaining delivery channels intersects with the first delivery channel, and
wherein the first delivery channel is arranged parallel to a reference plane where the microfluidic chip is located, and each of the remaining delivery channels has a slope relative to the first delivery channel.

10. (canceled)

11. (canceled)

12. The microfluidic chip according to claim 2, wherein the delivery channels of all units are arranged in a spiral manner in the first direction, and any two adjacent delivery channels in the first direction among the delivery channels of all units are directly connected to each other.

13. (canceled)

14. (canceled)

15. The microfluidic chip according to claim 2, further comprising a collector downstream of the delivery channel,
wherein the collector comprises a first sub-collector, and the first sub-collector communicates with the fluid outlet of the first delivery channel.

16. (canceled)

17. The microfluidic chip according to claim 2, further comprising:
a collector downstream of the delivery channel, and
a sorting channel between the fluid outlet of the first delivery channel and the collector,
wherein the collector comprises a first sub-collector and a second sub-collector, and
wherein the sorting channel comprises a first sub-sorting channel and a second sub-sorting channel, the first sub-sorting channel communicates with the first sub-collector, and the second sub-sorting channel communicates with the second sub-collector.

18. (canceled)

19. (canceled)

20. The microfluidic chip according to claim 4, further comprising a third inlet,
wherein the generation part of each unit further comprises a third channel, the first channel, the second channel and the third channel merge at the confluence region, and
wherein the third channels of all units communicate with each other via a third connection channel, and the third channels of all units share the third inlet.

21. The microfluidic chip according to claim 5, further comprising at least two third inlets corresponding to the at least two units one by one,
wherein the generation part of each unit further comprises a third channel, the first channel, the second channel and the third channel merge at the confluence region, and
wherein the third channel of each of the at least two units corresponds to a respective one of the at least two third inlets.

22. The microfluidic chip according to claim 1, wherein the generation part of each unit comprises a first channel and a second channel which merge at a confluence region, one of the first channel and the second channel comprises at least one concave structure at the confluence region, a size of the first channel or the second channel comprising the concave structure at the confluence region is smaller than a size of a channel at a non-confluence region.

23. The microfluidic chip according to claim 22, wherein the first channel has a first width along a second direction at the non-confluence region, the second channel has a second width along a third direction at the non-confluence region, and the second direction is substantially perpendicular to the third direction and both the second direction and the third direction are in a reference plane parallel to the microfluidic chip.

24. The microfluidic chip according to claim 23, wherein the first channel comprises two symmetrical concave structures at the confluence region, a ratio of a width of each of the two symmetrical concave structures along the second direction to the first width is ⅙ to ⅓, and a height of each of the two symmetrical concave structures along the third direction is equal to the second width.

25. The microfluidic chip according to claim 23, wherein the second channel comprises the concave structure at the confluence region, and a ratio of a height of the concave structure along the third direction to the second width is ¼ to ½.

26. The microfluidic chip according to claim 25, wherein a ratio of a width of the concave structure along the second direction to the first width is ⅓ to ⅔, and a centerline of the concave structure along the third direction coincides with a centerline of the first channel along the third direction.

27. The microfluidic chip according to claim 25,
wherein a width of the concave structure along the second direction is equal to the first width, and a centerline of the concave structure along the third direction coincides with a centerline of the first channel along the third direction; or
wherein a width of the concave structure along the second direction is equal to the first width, a centerline of the concave structure along the third direction is offset in the second direction relative to a centerline of the first channel along the third direction, and a ratio of an offset distance to the first width is ⅓ to 1.

28. (canceled)

29. The microfluidic chip according to claim 23,
wherein the generation part of each unit further comprises a third channel, the second channel is between the first channel and the third channel, and the first channel, the second channel and the third channel merge at the confluence region, and
wherein the first channel comprises a first concave structure at the confluence region, the third channel comprises a second concave structure at the confluence region, and the first concave structure and the second concave structure are symmetrical about the second channel.

30. The microfluidic chip according to claim 29,
wherein a non-confluence region of the third channel has a third width along the second direction, the third width is equal to the first width, and
wherein a ratio of a width of each of the first concave structure and the second concave structure along the second direction to the first width is ¼ to ½, and a height of each of the first concave structure and the second concave structure along the third direction is equal to the second width.

31. A microfluidic device comprising the microfluidic chip according to claim 1.
